(19) United States
(12) Patent Application Publication
(10) Pub. No.: US 2026/0342202 A1
(43) Pub. Date: Oct. 29, 2026

(54) Charging Circuit and the Control Method thereof

(71) Applicant: Silicon-Magic Semiconductor Technology (Hangzhou) Co., Ltd., Hangzhou (CN)

(72) Inventors: Qiwei Huang, Hangzhou (CN); Linghua Huang, Hangzhou (CN)

(73) Assignee: Silicon-Magic Semiconductor Technology (Hangzhou) Co., Ltd., Hangzhou (CN)

(21) Appl. No.: 19/653,014

(22) Filed: Apr. 20, 2026

(30) Foreign Application Priority Data
Apr. 25, 2025 (CN) 2025105282341

(51) Int. Cl. H02M 1/00; H02J 7/64; H02J 7/68; H02M 1/32; H02M 3/07

(52) U.S. Cl. CPC H02M 1/0045; H02J 7/64; H02J 7/68; H02M 1/0095; H02M 1/32; H02M 3/07; H02J 2207/20

(57) ABSTRACT

A charging circuit, having a charge pump circuit and a linear control circuit. The charge pump circuit is configured to receive a charge pump input voltage and to provide an output voltage. The charge pump circuit includes a plurality of charge pump power transistors, a subset of which forms a linear current channel circuit. The linear control circuit provides a first linear control signal to the linear current channel circuit, to enable the charge pump circuit to operate in linear mode. The charge pump circuit is further configured to receive a charge pump control signal. When the charge pump circuit operates in a switching mode, the plurality of charge pump power transistors in the charge pump circuit are switched by the charge pump control signal.

### CROSS-REFERENCE TO RELATED APPLICATION

This application claims the benefit of Chinese patent application No. 202510528234.1, filed on Apr. 25^{th}, 2025, which is incorporated herein by reference in its entirety.

### TECHNICAL FIELD

This application relates to the field of power electronics, particularly to charging circuits and the associated control method thereof.

### BACKGROUND

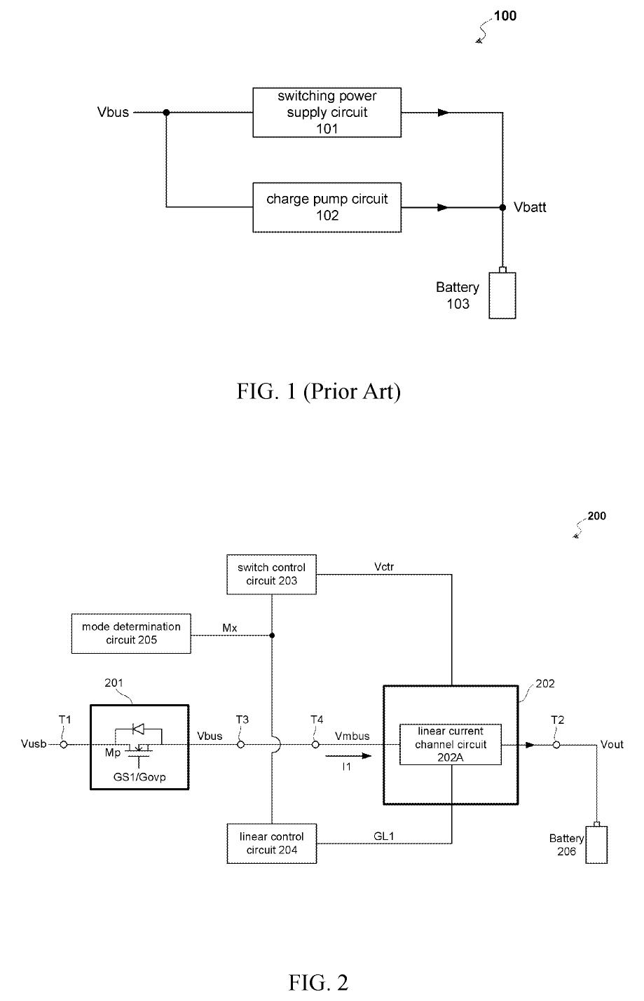

With the popularity of fast charge technology, mid-to-high-end smartphones and other devices are generally equipped with fast charging functions. Charge pump circuits, due to their high charging efficiency, are widely used in fast charging technology. FIG. 1 schematically illustrates a prior art battery fast charging system 100, including a switching power supply circuit 101 and a charge pump circuit 102. During the fast-charging stage, the charge pump circuit 102 charges the battery 103 with high power. When the battery is at a low battery condition, the switching power supply circuit 101 provides trickle charging until the battery voltage reaches a certain value, then the charge pump circuit 102 is used for high power charging. On some smartphones, the charge pump circuit 102 is operational only when a compatible fast-charging adapter is connected; otherwise, charging will proceed solely via the switching power supply circuit 101, and fast charging will not be achieved.

### SUMMARY

It is an object of the present disclosure to provide a charging circuit. In the embodiments of the present disclosure, while achieving high power charging by utilizing a charge pump circuit, the charging circuit also realizes low power charging in some states through controlling a subset of the charge pump power transistors of the charge pump circuit, thereby simplifying circuit design and reducing circuit cost.

The embodiments of the present disclosure are directed to a charging circuit including a charge pump circuit and a linear control circuit. The charge pump circuit has a first terminal coupled to a charge pump input terminal, a second terminal coupled to an output voltage terminal, and a ground reference terminal. The charge pump input terminal is configured to receive a charge pump input voltage and the output voltage terminal is configured to provide an output voltage. The charge pump circuit includes a plurality of charge pump power transistors, a subset of which is configured to form a linear current channel circuit. The linear control circuit configured to provide a first linear control signal to the linear current channel circuit, to enable the charge pump circuit to operate in a linear mode, wherein, in the linear mode, the charge pump power transistors in the linear current channel circuit are turned on under control of the first linear control signal, while remaining ones of the plurality of charge pump power transistors in the charge pump circuit are turned off. The charge pump circuit is further configured to receive a charge pump control signal, and when the charge pump circuit operates in a switching mode, the plurality of charge pump power transistors in the charge pump circuit are switched by the charge pump control signal.

In one embodiment, the linear control circuit includes a first differential regulation circuit configured to receive the charge pump input voltage and the output voltage, and to provide the first linear control signal based on the charge pump input voltage and the output voltage.

In one embodiment, the charging circuit further includes an overvoltage protection circuit. The overvoltage protection circuit has a first terminal coupled to an input voltage terminal, a second terminal coupled to a bus voltage terminal, and a control terminal. The linear control circuit is further configured to provide a second linear control signal to the control terminal of the overvoltage protection circuit. When the charge pump circuit operates in the linear mode, the overvoltage protection circuit is controlled by the second linear control signal to provide a current path from the input voltage terminal to the bus voltage terminal. When the charge pump circuit operates in the switching mode, the overvoltage protection circuit is maintained in a pass-through state under control of a first protection switch control signal.

In one embodiment, the charging circuit further includes a reverse current blocking circuit. The reverse current blocking circuit has a first terminal coupled to a bus voltage terminal, a second terminal coupled to the charge pump input terminal, and a control terminal. The linear control circuit further provides a third linear control signal to the control terminal of the reverse current blocking circuit. When the charge pump circuit operates in the linear mode, the reverse current blocking circuit is controlled by the third linear control signal to provide a current path from the bus voltage terminal to the charge pump input terminal. When the charge pump circuit operates in the switching mode, the reverse current blocking circuit is maintained in a pass-through state under control of a second protection switch control signal.

In one embodiment, the charging circuit further comprises an overvoltage protection circuit and a reverse current blocking circuit. The overvoltage protection circuit has a first terminal coupled to an input voltage terminal, a second terminal coupled to a bus voltage terminal, and a control terminal. The reverse current blocking circuit has a first terminal coupled to the bus voltage terminal, a second terminal coupled to the charge pump input terminal, and a control terminal. The linear control circuit further provides a second linear control signal to the control terminal of the overvoltage protection circuit and to provide a third linear control signal to the control terminal of the reverse current blocking circuit. When the charge pump circuit operates in the linear mode, the overvoltage protection circuit is controlled by the second linear control signal to provide a current path from the input voltage terminal to the bus voltage terminal, and the reverse current blocking circuit is controlled by the third linear control signal to provide a current path from the bus voltage terminal to the charge pump input terminal. When the charge pump circuit operates in the switching mode, the overvoltage protection circuit is maintained in a pass-through state under control of a first protection switch control signal, and the reverse current blocking circuit is maintained in a pass-through state under control of a second protection switch control signal.

In one embodiment, the charge pump circuit includes a first charge pump power transistor, a second charge pump power transistor, a third charge pump power transistor, a fourth charge pump power transistor and a first flying capacitor. The first charge pump power transistor, the second charge pump power transistor, the third charge pump power transistor, and the fourth charge pump power transistor are coupled in series between the first terminal and the ground reference terminal of the charge pump circuit. The first flying capacitor has a first terminal coupled to a connecting node of the first charge pump power transistor and the second charge pump power transistor, and a second terminal coupled to a connecting node of the third charge pump power transistor and the fourth charge pump power transistor. A connecting node of the second charge pump power transistor and the third charge pump power transistor is coupled to the output voltage terminal. The linear current channel circuit includes the first charge pump power transistor and the second charge pump power transistor.

In one embodiment, the charge pump circuit includes a first charge pump power transistor, a second charge pump power transistor, a third charge pump power transistor, a fourth charge pump power transistor, a fifth charge pump power transistor, a sixth charge pump power transistor, a seventh charge pump power transistor, an eighth charge pump power transistor, a first flying capacitor and a second flying capacitor. The first charge pump power transistor, the second charge pump power transistor, the third charge pump power transistor and the fourth charge pump power transistor are coupled in series between the first terminal and the ground reference terminal of the charge pump circuit. The first flying capacitor has a first terminal coupled to a connecting node of the first charge pump power transistor and the second charge pump power transistor, and a second terminal coupled to a connecting node of the third charge pump power transistor and the fourth charge pump power transistor. A connecting node of the second charge pump power transistor and the third charge pump power transistor is coupled to the output voltage terminal. The fifth charge pump power transistor, the sixth charge pump power transistor, the seventh charge pump power transistor, and the eighth charge pump power transistor are coupled in series between the first terminal and the ground reference terminal of the charge pump circuit. The second flying capacitor has a first terminal coupled to a connecting node of the fifth charge pump power transistor and the sixth charge pump power transistor, and a second terminal coupled to a connecting node of the seventh charge pump power transistor and the eighth charge pump power transistor. A connecting node of the sixth charge pump power transistor and the seventh charge pump power transistor is coupled to the output voltage terminal. The linear current channel circuit includes the first charge pump power transistor, the second charge pump power transistor, the fifth charge pump power transistor and the sixth charge pump power transistor.

In one embodiment, the charge pump circuit includes a first charge pump power transistor, a second charge pump power transistor, a third charge pump power transistor, a fourth charge pump power transistor, a fifth charge pump power transistor, a sixth charge pump power transistor, a seventh charge pump power transistor, an eighth charge pump power transistor, a first flying capacitor, a second flying capacitor and a third flying capacitor. The first charge pump power transistor, the second charge pump power transistor, the third charge pump power transistor and the fourth charge pump power transistor are coupled in series between the first terminal and the output voltage terminal, the fifth charge pump power transistor and the sixth charge pump power transistor are coupled in series between the output voltage terminal and the ground reference terminal, the seventh charge pump power transistor and the eighth charge pump power transistor are coupled in series between the output voltage terminal and the ground reference terminal. The first flying capacitor has a first terminal coupled to a connecting node of the first charge pump power transistor and the second charge pump power transistor, and a second terminal coupled to a connecting node of the fifth charge pump power transistor and the sixth charge pump power transistor. The second flying capacitor has a first terminal coupled to a connecting node of the third charge pump power transistor and the fourth charge pump power transistor, and a second terminal coupled to the connecting node of the fifth charge pump power transistor and the sixth charge pump power transistor. The third flying capacitor has a first terminal coupled to a connecting node of the second charge pump power transistor and the third charge pump power transistor, and a second terminal coupled to a connecting node of the seventh charge pump power transistor and the eighth charge pump power transistor. The linear current channel circuit includes the first charge pump power transistor, the second charge pump power transistor, the third charge pump power transistor and the fourth charge pump power transistor.

The embodiments of the present disclosure are directed to a control method for controlling the aforementioned charging circuit. The control method includes steps of: determining an operating mode of the charging circuit; when the charging circuit operates in a switching mode, turning on and off the charge pump power transistors of the charge pump circuit in a pattern; and when the charging circuit operates in a linear mode, controlling a linear current channel circuit in the charge pump circuit to operate in the linear mode. The linear current channel circuit includes the charge pump power transistors coupled in series between the charge pump input terminal and the output voltage terminal.

In one embodiment, controlling the linear current channel circuit in the charge pump circuit to operate in the linear mode includes providing a first linear control signal based on a voltage difference between the charge pump input terminal and the output voltage terminal, to control the charge pump power transistors in the linear current channel circuit to provide a current path.

In one embodiment, an overvoltage protection circuit is coupled between the input voltage terminal and the bus voltage terminal of the charging circuit and the control method further includes: in the linear mode, controlling the one or more series-connected overvoltage protection power transistors based on a second linear control signal, wherein the second linear control signal is generated based on a voltage difference between an input terminal and an output terminal of the overvoltage protection circuit; in the switching mode, controlling the one or more series-connected overvoltage protection power transistors based on a first protection switch control signal.

In one embodiment, a reverse current blocking circuit is coupled between the bus voltage terminal and the charge pump input terminal of the charging circuit. The reverse current blocking circuit includes at least one reverse current blocking power transistor, and the control method further includes: in the linear mode, controlling the at least one reverse current blocking power transistor based on a third linear control signal, wherein the third linear control signal is generated based on a voltage difference between an input terminal and an output terminal of the reverse current blocking circuit; in the switching mode, controlling the at least one reverse current blocking power transistor based on a second protection switch control signal.

### BRIEF DESCRIPTION OF FIGS

The present disclosure can be further understood with reference to following detailed description and appended drawings, wherein like elements are provided with like reference numerals. These drawings are only for illustration purpose, thus may only show part of the devices and are not necessarily drawn to scale. It is obvious that the drawings described below are some implementations of the present disclosure, and those skilled in the art would also obtain other drawings on the basis of these drawings, without involving any inventive skill.

FIG. 1 schematically illustrates a prior art battery fast charging system 100.

FIG. 2 schematically illustrates a charging circuit 200 in accordance with an embodiment of the present disclosure.

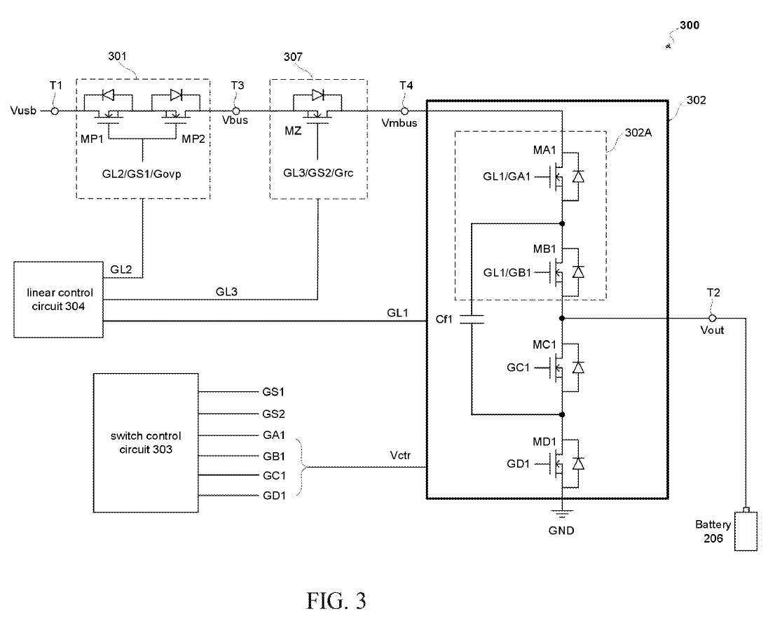

FIG. 3 schematically illustrates a charging circuit 300 in accordance with another embodiment of the present disclosure.

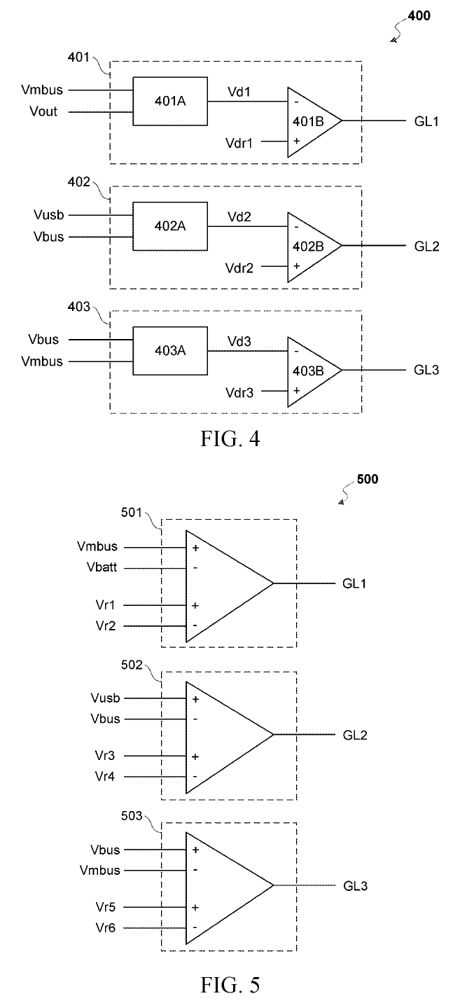

FIG. 4 schematically illustrates a linear control circuit 400 in accordance with an embodiment of the present disclosure.

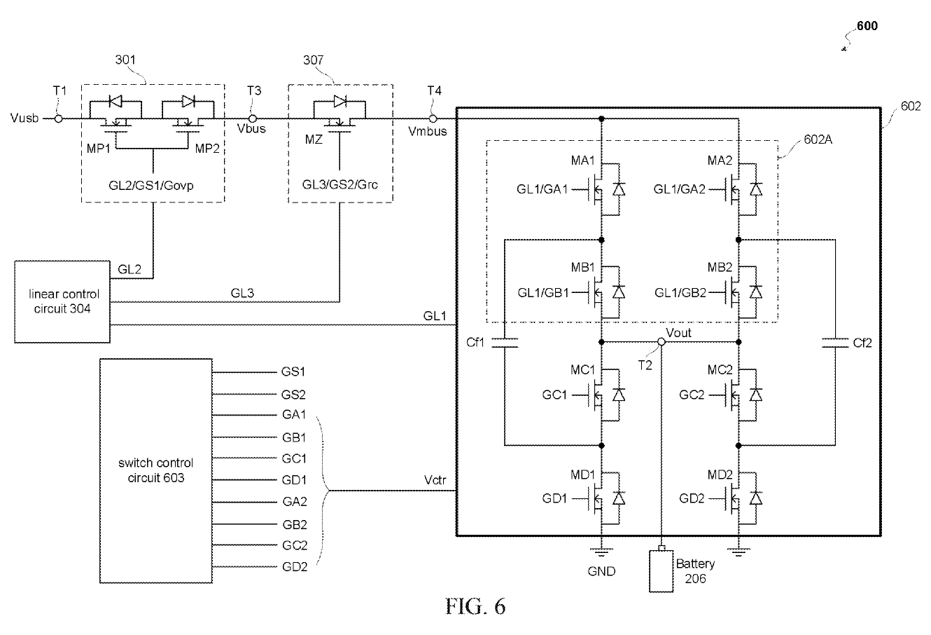

FIG. 5 schematically illustrates a linear control circuit 500 in accordance with another embodiment of the present disclosure.

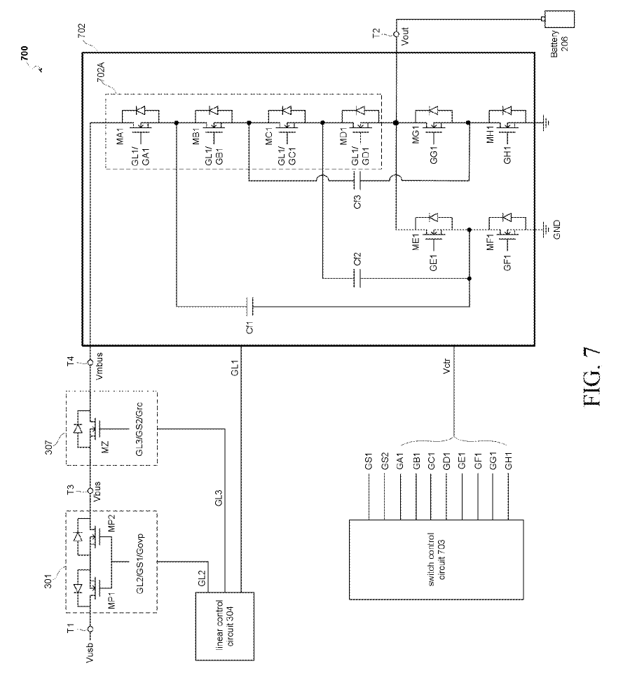

FIG. 6 schematically illustrates a charging circuit 600 in accordance with an embodiment of the present disclosure.

FIG. 7 schematically illustrates a charging circuit 700 in accordance with an embodiment of the present disclosure.

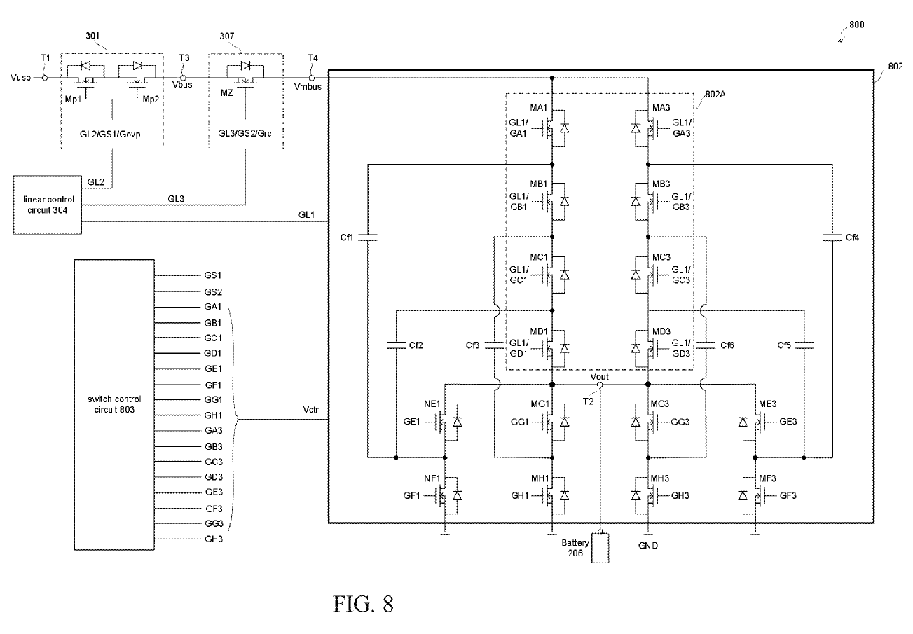

FIG. 8 schematically illustrates a charging circuit 800 in accordance with an embodiment of the present disclosure.

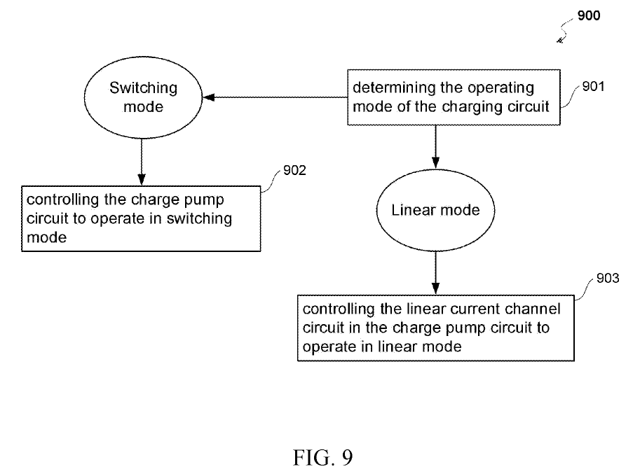

FIG. 9 schematically illustrates a control method 900 for a charging circuit in accordance with an embodiment of the present disclosure.

The use of the same reference label in different drawings indicates the same or like components.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

The terms “first,” “second,” etc., in the following description are used solely for clarity of description and should not be construed as indicating or implying relative importance or implicitly indicating the number of the described technical features. Features defined with “first,” “second,” etc., may explicitly or implicitly include one or more such features. In this disclosure, unless otherwise specified, “multiple” means two or more.

In the present disclosure, unless otherwise expressly specified or limited, the term “connect” should be understood broadly, e.g., “connect” can mean a fixed connection, a detachable connection, or integration; it can be a direct connection or an indirect connection through an intermediate medium. In addition, the term “couple” may refer to an electrical connection that enables signal transmission. “Couple” can mean a direct electrical connection or an indirect electrical connection through an intermediate medium.

FIG. 2 schematically illustrates a charging circuit 200 in accordance with an embodiment of the present disclosure. As shown in FIG. 2, the charging circuit 200 includes an overvoltage protection circuit 201, a charge pump circuit 202, a switch control circuit 203, and a linear control circuit 204. The charging circuit 200 has an input voltage terminal T1 configured to receive an input voltage Vusb, and an output voltage terminal T2 configured to receive an output voltage Vout. When the charging circuit 200 is employed to charge a battery in a charging device, the input voltage terminal T1 is connected to a USB interface to receive the input voltage Vusb, and the output voltage terminal T2 is coupled to a battery 206 as shown in FIG. 2.

The overvoltage protection circuit 201 is employed to prevent an excessively high input voltage Vusb from damaging subsequent circuits and loads (i.e., the battery). In the embodiment shown in FIG. 2, the overvoltage protection circuit 201 has a first terminal, a second terminal, and a control terminal. The first terminal of the overvoltage protection circuit 201 is coupled to the input voltage terminal T1, the second terminal is coupled to a bus voltage terminal T3, and the control terminal receives an overvoltage protection signal Govp. The overvoltage protection signal Govp is generated based on the input voltage Vusb. When the input voltage Vusb exceeds a certain level, i.e., higher than an overvoltage threshold, the subsequent circuits coupled to the input voltage terminal T1 via the overvoltage protection circuit 201 are disconnected from the input voltage Vusb by the overvoltage protection circuit 201. For clarity of illustration, the control circuit for generating the overvoltage protection signal Govp is not shown in FIG. 2. In one embodiment, a comparator circuit may be employed to compare the input voltage Vusb with the overvoltage threshold to generate the overvoltage protection signal Govp.

In the embodiment of FIG. 2, the overvoltage protection circuit 201 includes an overvoltage protection power transistor MP, which is a MOSFET (Metal-Oxide-Semiconductor Field-Effect Transistor). It should be understood that other controllable power transistors, such as JFETs, may also be employed for the overvoltage protection circuit 201. In FIG. 2, a drain terminal of the overvoltage protection power transistor MP is coupled to the input voltage terminal T1, and a source terminal is coupled to the bus voltage terminal T3.

The bus voltage terminal T3 provides a bus voltage Vbus, to the charge pump circuit 202 and may also to other loads (not shown in the FIGs of the present disclosure). When the input voltage Vusb is in the normal range (not in an overvoltage condition), the first protection switch control signal GS1 that controls the overvoltage protection circuit 201 is at a high level, thus the overvoltage protection circuit 201 is in a pass-through state (i.e., fully turned on) and connects the input voltage terminal T1 and the bus voltage terminal T3. The value of the bus voltage Vbus is approximately equal to the input voltage Vusb, and a difference is equal to a conduction voltage of the overvoltage protection circuit 201, i.e., the voltage difference between the first and second terminals of the overvoltage protection circuit 201, which is the drain-source voltage of the overvoltage protection transistor Mp in the embodiment of FIG. 2. In other embodiments, the control signal Govp is set according to the structure of the overvoltage protection circuit 201. Generally, the overvoltage protection circuit 201 is configured to electrically connect the input voltage terminal T1 to the bus voltage terminal T3 when the input voltage Vusb is below the overvoltage threshold, and to disconnect the terminals T1 and T3 when the input voltage Vusb exceeds the overvoltage threshold.

The overvoltage protection circuit 201 and the charge pump circuit 202 may be integrated on the same chip or on independent chips.

In the embodiment of FIG. 2, the charge pump circuit 202 has a first terminal coupled to the charge pump input terminal T4 and a second terminal coupled to the output voltage terminal T2. The charge pump circuit 202 includes switches and capacitors coupled in a specific configuration. Based on the voltage at the charge pump input terminal T4, the charge pump circuit 202 provides an output voltage Vout at the output voltage terminal T2 to the subsequent load, i.e., battery 206. The bus voltage terminal T3 and the charge pump input terminal T4 may be directly connected or may include intermediate circuits such as a reverse current blocking circuit. In the embodiment of FIG. 2, The terminals T3 and T4 are directly connected, thus a charge pump input voltage Vmbus is equal to the bus voltage Vbus.

The charge pump circuit 202 includes a linear current channel circuit 202A, which comprises at least one power transistor coupled between the charge pump input terminal T4 and the output voltage terminal T2.

In the embodiment of FIG. 2, the switch control circuit 203 has an output terminal for providing a charge pump control signal Vctr to the charge pump circuit 202, for controlling the charge pump circuit 202 to operate in switching mode to charge battery 206. In the switching mode, the power transistors of the charge pump circuit 202 are turned on or off in a specific pattern, operating as a charge pump. The charge pump control signal Vctr may include a plurality of switch control signals, each controlling the respective power transistor in the charge pump circuit 202.

In the embodiment of FIG. 2, the linear control circuit 204 has an output terminal that provides a first linear control signal GL1 to the linear current channel circuit 202A, to control the linear current channel circuit 202A to operate in a linear mode. In the linear mode, the power transistors in the linear current channel circuit 202A operate in the linear or saturation region. When the linear current channel circuit 202A is working in the linear mode, the overvoltage protection circuit 201 and the linear current channel circuit 202A form a current path between the input voltage terminal T1 and the output voltage terminal T2 to charge the battery 206.

In the embodiment of FIG. 2, the charging circuit 200 further includes a mode determination circuit 205 for controlling the switch control circuit 203 and the linear control circuit 204. When the battery is being charged, i.e., when the input voltage terminal T1 is connected to a USB interface, the charger and the device (such as a mobile phone or tablet) in which the battery 206 is housed perform a handshake through a specific communication protocol to determine whether the charging circuit 200 should charge the battery 206 in the linear mode or the switching mode. The mode determination circuit 205 provides a mode determination signal Mx for controlling the switch control circuit 203 and the linear control circuit 204. In one embodiment, when the mode determination signal Mx indicates that the charging circuit 200 is operating in the linear mode, the switch control circuit 203 stops operating or stops providing the charge pump control signal Vctr, and the linear control circuit 204 controls the linear current channel circuit 202A to operate. When the mode determination signal Mx indicates that the charging circuit 200 is operating in the switching mode, the linear control circuit 204 stops operating or stops providing the first linear control signal GL1, and the switch control circuit 203 provides the charge pump control signal Vctr to control the charge pump circuit 202 to operate in the switching mode.

In some embodiments, the mode determination circuit 205 determines the operating mode of the charging circuit 200 based on circuit parameters, such as the value of the input voltage Vusb or the current at the input voltage terminal T1. In some embodiments, the mode determination circuit 205 determines the operating mode of the charging circuit 200 based on user settings.

The mode determination circuit 205 may be implemented as an analog or digital circuit as required by the application. In some embodiments, the mode determination circuit 205 and the other circuits of the charging circuit 200 are integrated on independent chips. In some embodiments, the mode determination signal Mx is provided by a higher-level controller and the mode determination circuit 205 may be omitted. In FIG. 2, the mode determination signal Mx is provided for illustration only and is not necessarily an actual signal. The mode determination signal Mx may be a real signal or a parameter in a register.

FIG. 3 schematically illustrates a charging circuit 300 in accordance with another embodiment of the present disclosure. As shown in FIG. 3, the charging circuit 300 includes an overvoltage protection circuit 301, a charge pump circuit 302, a reverse current blocking circuit 307, a switch control circuit 303, and a linear control circuit 304. The charging circuit 300 has an input voltage terminal T1 configured to receive the input voltage Vusb and an output voltage terminal T2 configured to provide the output voltage Vout. When the charging circuit 300 is configured for charging a battery, the input voltage terminal T1 is connected to a USB interface to receive input voltage Vusb, and the output voltage terminal T2 is coupled to the battery 206.

In the embodiment of FIG. 3, the overvoltage protection circuit 301 has a first terminal, a second terminal, and a control terminal. The first terminal is coupled to the input voltage terminal T1, the second terminal is coupled to the bus voltage terminal T3, and the control terminal is configured to receive a first protection switch control signal GS1, a second linear control signal GL2, and an overvoltage protection signal Govp.

In the embodiment of FIG. 3, the overvoltage protection circuit 301 includes a first overvoltage protection power transistor MP1 and a second overvoltage protection power transistor MP2. Both the first overvoltage protection power transistor MP1 and the second overvoltage protection power transistor MP2 are MOSFETs (Metal-Oxide-Semiconductor Field-Effect Transistors). In some embodiments, other controllable power transistors, such as JFETs, may also be employed as the first overvoltage protection power transistor MP1 and the second overvoltage protection power transistor MP2. Each one of the first overvoltage protection power transistor MP1 and the second overvoltage protection power transistor MP2 has a source terminal, a drain terminal, and a gate terminal. In FIG. 3, the drain terminal of the first overvoltage protection power transistor MP1 is coupled to the input voltage terminal T1, the source terminal of the first overvoltage protection power transistor MP1 is coupled to the source terminal of the second overvoltage protection power transistor MP2, and the drain terminal of the second overvoltage protection power transistor MP2 is coupled to the bus voltage terminal T3. The gate terminals of both the first overvoltage protection power transistor MP1 and the second overvoltage protection power transistor MP2 are coupled together to receive the first protection switch control signal GS1, the second linear control signal GL2, and the overvoltage protection signal Govp. In some embodiments, the first overvoltage protection power transistor MP1 and the second overvoltage protection power transistor MP2 may be swapped in position. The overvoltage protection power transistors MP1 and MP2 are illustrated as N-type MOSFETs in FIG. 3. One skilled in the art will recognize that P-type MOSFETs or other suitable switching devices may alternatively be employed, with appropriate adjustments to the gate drive logic and circuit connections, without departing from the scope of the present disclosure.

When the charging circuit 300 is operating in the switching mode, the first overvoltage protection power transistor MP1 and the second overvoltage protection power transistor MP2 are kept fully on under the control of the first protection switch control signal GS1, and the input voltage Vusb at the input voltage terminal T1 is close to or may be slightly higher than the bus voltage Vbus at the bus voltage terminal T3. When the charging circuit 300 is operating in the linear mode, the first overvoltage protection power transistor MP1 and the second overvoltage protection power transistor MP2 operate in linear or saturation region under the control of the second linear control signal GL2, providing a current path between the input voltage terminal T1 and the bus voltage terminal T3. The conduction level of each of the first overvoltage protection power transistor MP1 and the second overvoltage protection power transistor MP2 is determined by the second linear control signal GL2. Upon detection of an overvoltage condition in the input voltage Vusb at the input voltage terminal T1, the first and second overvoltage protection power transistors MP1, MP2 are turned off by the overvoltage protection signal Govp to prevent damage to post-stage circuitry.

In the embodiment of FIG. 3, the charge pump circuit 302 has a first terminal coupled to the charge pump input terminal T4 and a second terminal coupled to the output voltage terminal T2. The charge pump circuit 302 includes a first charge pump power transistor MA1, a second charge pump power transistor MB1, a third charge pump power transistor MC1, a fourth charge pump power transistor MD1, and a first flying capacitor Cf1. The charge pump power transistors MA1, MB1, MC1 and MD1 are coupled in series between the first terminal of the charge pump circuit 302 and the ground reference terminal GND. The first flying capacitor Cf1 has a first terminal coupled to the connecting node of the first charge pump power transistor MA1 and the second charge pump power transistor MB1, and a second terminal coupled to the connecting node of the third charge pump power transistor MC1 and the fourth charge pump power transistor MD1. The connecting node of the second charge pump power transistor MB1 and the third charge pump power transistor MC1 is coupled to output voltage terminal T2.

The charge pump circuit 302 includes a linear current channel circuit 302A, which includes power transistors coupled in series between the charge pump input terminal T4 and the output voltage terminal T2. In the embodiment of FIG. 3, the linear current channel circuit 302A includes the first charge pump power transistor MA1 and the second charge pump power transistor MB1. In the linear mode, the first charge pump power transistor MA1 and the second charge pump power transistor MB1 are turned on and regulated by the first linear control signal GL1, and the third charge pump power transistor MC1 and the fourth charge pump power transistor MD1 are maintained in an off state. In the switching mode, the charge pump power transistors MA1, MB1, MC1, and MD1 are turned on or off respectively by switch control signals GA1, GB1, GC1, and GD1, which are components of the charge pump control signal Vctr.

In the embodiment of FIG. 3, the reverse current blocking circuit 307 is coupled between the bus voltage terminal T3 and the charge pump input terminal T4. The reverse current blocking circuit 307 includes a reverse current blocking power transistor MZ. The reverse current blocking power transistor MZ has a source terminal coupled to the bus voltage terminal T3, a drain terminal coupled to the charge pump input terminal T4, and a gate terminal configured to receive a reverse current blocking control signal Grc. In the switching mode, the reverse current blocking power transistor MZ is kept fully on by a second protection switch control signal GS2, such that the charge pump input voltage Vmbus at the charge pump input terminal T4 is close to the bus voltage Vbus at the bus voltage terminal T3. In the linear mode, the reverse current blocking power transistor MZ is controlled and regulated by a third linear control signal GL3 and operates in the linear or saturation region, providing a current path between the bus voltage terminal T3 and the charge pump input terminal T4. The conduction level is controlled by the third linear control signal GL3. When a reverse current is detected at the charge pump input terminal T4 or when the charge pump input voltage Vmbus exceeding the bus voltage Vbus is detected, the reverse current blocking control signal Grc turns off the reverse current blocking power transistor MZ to prevent reverse current from the charge pump input terminal T4 to the bus voltage terminal T3. The reverse current blocking power transistor MZ is illustrated as N-type MOSFETs in FIG. 3. One skilled in the art will recognize that P-type MOSFETs or other suitable switching devices may alternatively be employed, with appropriate adjustments to the gate drive logic and circuit connections, without departing from the scope of the present disclosure.

It should be understood that in some embodiments, reverse current blocking circuit 307 may be implemented with other circuits, such as diodes, in which case no control signal is required.

The switch control circuit 303 provides the charge pump control signal Vctr to the charge pump circuit 302 for switching mode operation and also provides the first and second switch protection control signals GS1, GS2 to the overvoltage protection circuit 301 and the reverse current blocking circuit 307, respectively, to maintain the power transistors of the overvoltage protection circuit 301 and the reverse current blocking circuit 307 in a pass-through state, i.e., fully on. The operation of charge pump circuit 302 in the switching mode is as follows: when the first charge pump power transistor MA1 and the third charge pump power transistor MC1 are on, and the second charge pump power transistor MB1 and the fourth charge pump power transistor MD1 are off, a current flows from the charge pump input terminal T4 through the first charge pump power transistor MA1, the first flying capacitor Cf1, and the third charge pump power transistor MC1 to the output voltage terminal T2, charging the battery 206 and the first flying capacitor Cf1; when the first charge pump power transistor MA1 and the third charge pump power transistor MC1 are off, and the second charge pump power transistor MB1 and the fourth charge pump power transistor MD1 are on, the second terminal of the first flying capacitor Cf1 is coupled to the ground reference terminal GND through the fourth charge pump power transistor MD1, and the first terminal of the first flying capacitor Cf1 charges the battery 206 through the second charge pump power transistor MB1. The switch control signals GA1, GB1, GC1, and GD1 control the switching of the charge pump power transistors MA1, MB1, MC1, and MD1, respectively. The switch control circuit 303 may be implemented by known analog or digital circuit. In some embodiments, the protection switch control signals GS1, GS2 and the switch control signals GA1, GB1, GC1, and GD1 are provided by a discrete control chip.

In the embodiment of FIG. 3, the linear control circuit 304 provides the first linear control signal GL1 to control the linear current channel circuit 302A operating in the linear mode, i.e., the first charge pump power transistor MA1 and the second charge pump power transistor MB1 are in the linear or saturation region. The linear control circuit 304 also provides the second linear control signal GL2 to the overvoltage protection circuit 301 to regulate the overvoltage protection power transistors MP1 and MP2, and the third linear control signal GL3 to the reverse current blocking circuit 307 to regulate the reverse current blocking power transistor MZ. When in the linear mode, the linear control circuit 304 controls the overvoltage protection circuit 301, the reverse current blocking circuit 307, and the linear current channel circuit 302A to form a current path to charge the battery 206. In the linear mode, the power transistors in the linear current channel circuit 302A are on, and the remaining ones of the power transistors in the charge pump circuit 302 remain off.

The charging circuit 300 may also include a mode determination circuit as in the embodiment of FIG. 2. A detailed description of the operation of the mode determination circuit is omitted herein for brevity, as it has been provided in the foregoing description.

FIG. 4 schematically illustrates a linear control circuit 400 in accordance with an embodiment of the present disclosure. The linear control circuit 400 may be employed by the charging circuit 300. As shown in FIG. 4, the linear control circuit 400 includes a first differential regulation circuit 401, a second differential regulation circuit 402, and a third differential regulation circuit 403. The first differential regulation circuit 401 receives the charge pump input voltage Vmbus and the output voltage Vout, and provides the first linear control signal GL1 based thereon. The second differential regulation circuit 402 receives the input voltage Vusb and the bus voltage Vbus, and provides the second linear control signal GL2 based thereon. The third differential regulation circuit 403 receives the bus voltage Vbus and the charge pump input voltage Vmbus, and provides the third linear control signal GL3 based thereon.

In the embodiment of FIG. 4, the first differential regulation circuit 401 includes a first subtractor circuit 401A and a first error amplifier circuit 401B. The first subtractor circuit 401A receives the charge pump input voltage Vmbus and the output voltage Vout, and provides a first difference voltage Vd1, representing a voltage difference between the charge pump input voltage Vmbus and the output voltage Vout. The first error amplifier circuit 401B receives a first difference voltage reference Vdr1 and the first difference voltage Vd1, and based thereon, provides the first linear control signal GL1.

The second differential regulation circuit 402 includes a second subtractor circuit 402A and a second error amplifier circuit 402B. The second subtractor circuit 402A receives the input voltage Vusb and the bus voltage Vbus, and provides a second difference voltage Vd2, representing the voltage difference between the input voltage Vusb and the intermediate bus voltage Vbus. The second error amplifier circuit 402B receives a second difference voltage reference Vdr2 and the second difference voltage Vd2, and based thereon, provides the second linear control signal GL2.

The third differential regulation circuit 403 includes a third subtractor circuit 403A and a third error amplifier circuit 403B. The third subtractor circuit 403A receives the bus voltage Vbus and the charge pump input voltage Vmbus, and provides a third difference voltage Vd3, representing the voltage difference between the intermediate bus voltage Vbus and the charge pump input voltage Vmbus. The third error amplifier circuit 403B receives a third difference voltage reference Vdr3 and the third difference voltage Vd3, and based thereon, provides the third linear control signal GL3.

In the embodiment of FIG. 4, any known circuit capable of calculating the difference between two input voltage signals may be adopted as the subtractor circuits 401A, 402A, and 403A. The input voltage Vusb, the bus voltage Vbus, the charge pump input voltage Vmbus, and the output voltage Vout may each represent the actual voltages or divided/scaled representations thereof, as required by the application.

The error amplifier circuits 401B, 402B, and 403B may include error amplifiers. The first linear control signal GL1 represents an amplified error based on the first difference voltage reference Vdr1 and the first difference voltage Vd1. Via the first linear control signal GL1, the error amplifier circuit 401B regulates the first charge pump power transistor MA1 and the second charge pump power transistor MB1 in the linear current channel circuit 302A, thereby controlling the voltage drop across the linear current channel circuit 302A (the difference between the charge pump input voltage Vmbus and the output voltage Vout), and thus the power consumption and heat dissipation of the linear current channel circuit 302A in the linear mode. Similarly, via the second linear control signal GL2, the second error amplifier circuit 402B regulates the first overvoltage protection power transistor MP1 and the second overvoltage protection power transistor MP2 in the overvoltage protection circuit 301, thereby controlling the voltage drop across the overvoltage protection circuit 301 (the difference between the input voltage Vusb and the intermediate bus voltage Vbus), and thus the power consumption and heat dissipation of the overvoltage protection circuit 301 in the linear mode. Via the third linear control signal GL3, the third error amplifier circuit 403B controls the reverse current blocking power transistor MZ in the reverse current blocking circuit 307, thereby controlling the voltage drop across the reverse current blocking circuit 307 (the difference between the intermediate bus voltage Vbus and the charge pump input voltage Vmbus), and thus the power consumption and heat dissipation of the reverse current blocking circuit 307 in the linear mode.

FIG. 5 schematically illustrates a linear control circuit 500 in accordance with another embodiment of the present disclosure. The linear control circuit 500 may also be employed by the charging circuit 300. As shown in FIG. 5, the linear control circuit 500 includes a first differential regulation circuit 501, a second differential regulation circuit 502, and a third differential regulation circuit 503. The first differential regulation circuit 501, the second differential regulation circuit 502, and the third differential regulation circuit 503 may include voltage difference amplifiers.

In the embodiment of FIG. 5, the first differential regulation circuit 501 receives the charge pump input voltage Vmbus, the output voltage Vout, a first voltage reference Vr1, and a second voltage reference Vr2, and provides the first linear control signal GL1 based thereon. The first linear control signal GL1 represents the amplified error between voltage differences, i.e., the voltage difference of the charge pump input voltage Vmbus and the output voltage Vout, and the voltage difference of the first voltage reference Vr1 and the second voltage reference Vr2. Via the first linear control signal GL1, the first differential regulation circuit 501 regulates the first charge pump power transistor MA1 and the second charge pump power transistor MB1 in the linear current channel circuit 302A, thereby controlling the voltage drop across the linear current channel circuit 302A, making it follow the voltage difference between Vr1 and Vr2, and thus controlling power consumption and heat dissipation of the linear current channel circuit 302A in the linear mode.

The second differential regulation circuit 502 receives the input voltage Vusb, the bus voltage Vbus, a third voltage reference Vr3, and a fourth voltage reference Vr4, and provides the second linear control signal GL2 based thereon. The second linear control signal GL2 represents the amplified error between voltage differences, i.e., the voltage difference of the input voltage Vusb and the bus voltage Vbus, and the voltage difference of the third voltage reference Vr3 and the fourth voltage reference Vr4. Via the second linear control signal GL2, the second differential regulation circuit 502 regulates the first overvoltage protection power transistor MP1 and the second overvoltage protection power transistor MP2 in the overvoltage protection circuit 301, thereby controlling the voltage drop across the overvoltage protection circuit 301, making it follow the voltage difference between Vr3 and Vr4, and thus controlling power consumption and heat dissipation of the overvoltage protection circuit 301 in linear mode.

The third differential regulation circuit 503 receives the bus voltage Vbus, the charge pump input voltage Vmbus, a fifth voltage reference Vr5, and a sixth voltage reference Vr6, and provides the third linear control signal GL3 based thereon. The third linear control signal GL3 represents the amplified error between voltage differences, i.e., the voltage difference of the bus voltage Vbus and the charge pump input voltage Vmbus, and the voltage difference of the fifth voltage reference Vr5 and the sixth voltage reference Vr6. Via the third linear control signal GL3, the third differential regulation circuit 503 regulates the reverse current blocking power transistor MZ in the reverse current blocking circuit 307, thereby controlling the voltage drop across the reverse current blocking circuit 307, making it follow the voltage difference between Vr5 and Vr6, and thus controlling power consumption and heat dissipation of the reverse current blocking circuit 307 in linear mode.

FIG. 6 schematically illustrates a charging circuit 600 in accordance with an embodiment of the present disclosure. As shown in FIG. 6, the charging circuit 600 includes the overvoltage protection circuit 301, a charge pump circuit 602, the reverse current blocking circuit 307, a switch control circuit 603, and the linear control circuit 304. Compared with FIG. 3, the structure of the charge pump circuit 602 is different from the charge pump circuit 302, and accordingly, the switch control circuit 603 is also different from the switch control circuit 303 in the embodiment of FIG. 3.

The operations of the overvoltage protection circuit 301, the reverse current blocking circuit 307, and the linear control circuit 304 are as described above, and a detailed description thereof is omitted herein for brevity.

In the embodiment of FIG. 6, the charge pump circuit 602 is a dual-phase charge pump circuit. Compared with the embodiment of FIG. 3, the charge pump circuit 602 includes two current paths. One current path is provided by the first phase circuit, which includes the charge pump power transistors MA1, MB1, MC1, MD1, and the first flying capacitor Cf1. The other current path is provided by the second phase circuit, which includes the charge pump power transistors MA2, MB2, MC2, MD2, and the second flying capacitor Cf2. The first and second phase circuits have the same structure and operation, but have complementary timings to reduce the output voltage ripple. The operation of a single current path, i.e., the charge pump circuit 302, has been described above. Therefore, a detailed description of the operation of the charge pump circuit 602 is omitted herein for brevity.

In FIG. 6, the charge pump circuit 602 includes a linear current channel circuit 602A, which includes the first charge pump power transistor MA1 and the second charge pump power transistor MB1 (in the first phase circuit), as well as the fifth charge pump power transistor MA2 and the sixth charge pump power transistor MB2 (in the second phase circuit), each of which is coupled in series between the charge pump input terminal T4 and the output voltage terminal T2. In the switching mode, all the power transistors in the charge pump circuit 602 (including the charge pump power transistors MA1, MB1, MA2, MB2) are turned on and off in a pattern by the charge pump control signal Vctr from the switch control circuit 603. In the linear mode, the first linear control signal GL1 from linear control circuit 304 controls the first charge pump power transistor MA1, the second charge pump power transistor MB1, the fifth charge pump power transistor MA2 and the sixth charge pump power transistor MB2 to operate in the linear/saturation region, forming current paths with the overvoltage protection circuit 301 and the reverse current blocking circuit 307 to charge the battery 206.

FIG. 7 schematically illustrates a charging circuit 700 in accordance with an embodiment of the present disclosure. As shown in FIG. 7, the charging circuit 700 includes the overvoltage protection circuit 301, a charge pump circuit 702, the reverse current blocking circuit 307, a switch control circuit 703, and the linear control circuit 304. Compared with the embodiment of FIG. 3, the structure of the charge pump circuit 702 is different from the charge pump circuit 302. Accordingly, the control circuit of the charge pump circuit 702, i.e., the switch control circuit 703 is different from the switch control circuit 303.

The operations of the overvoltage protection circuit 301, the reverse current blocking circuit 307, and the linear control circuit 304 have already been described and will not be repeated for brevity.

In the embodiment of FIG. 7, the charge pump circuit 702 includes the first charge pump power transistor MA1, the second charge pump power transistor MB1, the third charge pump power transistor MC1, the fourth charge pump power transistor MD1, the fifth charge pump power transistor ME1, the sixth charge pump power transistor MF1, the seventh charge pump power transistor MG1, the eighth charge pump power transistor MH1, the first flying capacitor Cf1, the second flying capacitor Cf2, and third flying capacitor Cf3. The charge pump power transistors MA1, MB1, MC1, and MD1 are coupled in series between the charge pump input terminal T4 and the output voltage terminal T2. The fifth charge pump power transistor ME1 and the sixth charge pump power transistor MF1 are coupled in series between the output voltage terminal T2 and the ground reference terminal GND. The seventh charge pump power transistor MG1 and the eighth charge pump power transistor MH1 are coupled in series between the output voltage terminal T2 and the ground reference terminal GND. The first terminal of the first flying capacitor Cf1 is coupled to the connecting node of the first charge pump power transistor MA1 and the second charge pump power transistor MB1, and the second terminal of the first flying capacitor Cf1 is coupled to the connecting node of the fifth charge pump power transistor ME1 and the sixth charge pump power transistor MF1. The first terminal of the second flying capacitor Cf2 is connected to the connecting node of the third charge pump power transistor MC1 and the fourth charge pump power transistor MD1, and the second terminal of the second flying capacitor Cf2 is coupled to the connecting node of the fifth charge pump power transistor ME1 and the sixth charge pump power transistor MF1. The first terminal of the third flying capacitor Cf3 is connected to the connecting node of the second charge pump power transistor MB1 and the third charge pump power transistor MC1, and the second terminal of the third flying capacitor Cf3 is coupled to the connecting node of the seventh charge pump power transistor MG1 and the eighth charge pump power transistor MH1.

In the embodiment of FIG. 7, the charge pump circuit 702 includes a linear current channel circuit 702A, which consists of the charge pump power transistors MA1, MB1, MC1, and MD1 connected in series between the charge pump input terminal T4 and the output voltage terminal T2. When the linear current channel circuit 702A operates in the linear mode, the charge pump power transistors MA1, MB1, MC1, and MD1 are turned on and regulated by the first linear control signal GL1, forming a current path with the overvoltage protection circuit 301 and the reverse current blocking circuit 307 to charge the battery 206.

In the switching mode, all of the charge pump power transistors in the charge pump circuit 702, including the charge pump power transistors MA1, MB1, MC1, MD1, ME1, MF1, MG1 and MH1, are switched on and off in a pattern under the control of the charge pump control signal Vctr from the switch control circuit 703, operating as a charge pump. The charge pump circuit 702 is a 4:1 charge pump, and the operation is well known to those skilled in the art, which will not be described in detail here.

FIG. 8 schematically illustrates a charging circuit 800 in accordance with an embodiment of the present disclosure. As shown in FIG. 8, the charging circuit 800 includes the overvoltage protection circuit 301, a charge pump circuit 802, the reverse current blocking circuit 307, a switch control circuit 803, and the linear control circuit 304. Compared with the embodiment of FIG. 7, the structure of the charge pump circuit 802 is different from the charge pump circuit 702, and accordingly, the switch control circuit 803 is different from the switch control circuit 703.

The operations of the overvoltage protection circuit 301, the reverse current blocking circuit 307, and the linear control circuit 304 have already been described and will not be repeated for brevity.

In the embodiment of FIG. 8, the charge pump circuit 802 is a dual-phase charge pump circuit. Compared with the embodiment of FIG. 7, the charge pump circuit 802 includes two current paths. One current path is provided by the first phase circuit, which includes the charge pump power transistors MA1, MB1, MC1, MD1, ME1, MF1, MG1, MH1, the first flying capacitor Cf1, the second flying capacitor Cf2, and the third flying capacitor Cf3. The other current path is provided by the second phase circuit, which includes the charge pump power transistors MA3, MB3, MC3, MD3, ME3, MF3, MG3, MH3, the fourth flying capacitor Cf4, the fifth flying capacitor Cf5, and the sixth flying capacitor Cf6. The first and second phase circuits have the same structure and operation, but have complementary timings to reduce the output voltage ripple. The operation of a single current path, i.e., the charge pump circuit 302, has been described above, therefore, a detailed description of the operation of the charge pump circuit 602 is omitted herein for brevity.

In the embodiment of FIG. 8, the charge pump circuit 802 includes a linear current channel circuit 802A, which includes the charge pump power transistors MA1, MB1, MC1, and MD1 (in the first phase circuit) coupled between the charge pump input terminal T4 and the output voltage terminal T2, and the charge pump power transistors MA3, MB3, MC3, and MD3 (in the second phase circuit) also coupled between the charge pump input terminal T4 and the output voltage terminal T2. In the switching mode, all the charge pump power transistors are switched on and off in a pattern under the control of the charge pump control signal Vctr from the switch control circuit 803. In the linear mode, the first linear control signal GL1 from the linear control circuit 304 controls the charge pump power transistors MA1, MB1, MC1, MD1, MA3, MB3, MC3, and MD3 to operate in the linear or saturation region, forming current paths with the overvoltage protection circuit 301 and the reverse current blocking circuit 307 to charge the battery 206.

In some embodiments of the present disclosure, the overvoltage protection circuit, the reverse current blocking circuit, and the linear current channel circuit in the charge pump circuit together form the current path in the linear mode, drawing current from the input voltage terminal (USB port) to the output voltage terminal to charge the battery or other load. It should be understood that in some embodiments, one or both of the overvoltage protection circuit and reverse current blocking circuit may be omitted. In such cases, the linear current channel circuit in the charge pump circuit alone may form the current path from the input voltage terminal to the output voltage terminal. In some embodiments, the linear current channel circuit may form a current path in combination with either the overvoltage protection circuit or the reverse current blocking circuit. In the case that the linear current channel circuit is coupled between the input voltage terminal and the output voltage terminal to form the current path, the associated linear control circuit provides the first linear control signal to control the linear current channel circuit. Accordingly, the second and third differential regulation circuits in FIGS. 4 and 5 may be omitted. In the case that the overvoltage protection circuit and the linear current channel circuit are coupled between the input voltage terminal and the output voltage terminal to form the current path, the linear control circuit provides both the first and second linear control signals. Accordingly, the third differential regulation circuit may be omitted. In the case that the linear current channel circuit and the reverse current blocking circuit are coupled between the input voltage terminal and the output voltage terminal to form the current path, the linear control circuit provides both the first and third linear control signals. Accordingly, the second differential regulation circuit may be omitted.

In some embodiments, one or both of the overvoltage protection circuit and reverse current blocking circuit are included in the current path, while the overvoltage protection circuit and the reverse current blocking circuit are maintained in a pass-through state without additional linear control, and are turned off by associated events, meaning the second differential regulation circuit or the third differential regulation circuit is optional.

FIG. 9 schematically illustrates a control method 900 for a charging circuit in accordance with an embodiment of the present disclosure. The control method 900 may be used with the circuits described in FIGS. 2, 3, 6, 7, or 8. The control method 900 includes steps 901–903.

In step 901, determining the operating mode of the charging circuit. If the charging circuit is in the switching mode, proceed to step 902; if the charging circuit is in the linear mode, proceed to step 903.

When an input voltage terminal of the charging circuit is connected to a USB interface, the charger and the device where the battery is housed, e.g., a phone or a tablet, performing a handshake via a specific communication protocol to determine whether to adopt the linear mode or the switching mode for charging. In some embodiments, the operating mode may be determined by detecting the value of the input voltage and/or input current of the charging circuit at the input voltage terminal. It should be understood that the embodiments of the present disclosure impose no limitation on the approach for determining the operating mode of the charging circuit. Any circuitry or system suitable for distinguishing and configuring the operating mode of the charging circuit may be employed in the embodiments of the present disclosure.

In step 902, controlling the charge pump circuit to operate in the switching mode. In the switching mode, the flying capacitor(s) is charged and discharged by switching on and off the charge pump power transistors in a pattern.

In step 903, controlling the linear current channel circuit in the charge pump circuit to operate in the linear mode.

The linear current channel circuit includes the charge pump power transistors coupled in series between a charge pump input voltage terminal and an output voltage terminal of the charging circuit. In one embodiment, the charge pump power transistors operate in the linear or saturation region in the linear mode.

In one embodiment, in the linear mode, a first linear control signal is provided based on a voltage difference between the charge pump input terminal and the output voltage terminal to control the charge pump power transistors in the linear current channel circuit. In one embodiment, when the voltage difference increases, the first linear control signal decreases and the current through the linear current channel circuit decreases; when the voltage difference decreases, the first linear control signal increases and the current through the linear current channel circuit increases.

In one embodiment, an overvoltage protection circuit is provided between the input voltage terminal and the charge pump input terminal, including one or more series coupled overvoltage protection power transistors. In the linear mode, the overvoltage protection power transistors are controlled by a second linear control signal based on the voltage difference across the overvoltage protection circuit. In the switching mode, the overvoltage protection power transistors are controlled by a first protection switch control signal, to be fully on. In response to an overvoltage condition, the overvoltage protection power transistors are turned off to protect the post-stage circuitry.

In one embodiment, a reverse current blocking circuit is further provided between the overvoltage protection circuit and the charge pump circuit, including at least one reverse current blocking power transistor. In the linear mode, the at least one reverse current blocking power transistor is controlled by a third linear control signal based on the voltage difference across the reverse current blocking circuit. In the switching mode, the at least one reverse current blocking power transistor is controlled by a second protection switch control signal, to be fully on. When a reverse current is detected, the at least one reverse current blocking power transistor is turned off.

It should be understood that the logic circuits and the respective non-inverting and inverting input terminals of the corresponding comparators and error amplifiers in the embodiments of the present disclosure are provided for illustrative purposes only. When the polarity of the signal is reversed, the logic circuits and the polarities of the respective input terminals may change accordingly.

The terms “at least one,” “multiple,” “and/or,” and “/” are to be interpreted broadly as described in the original, covering all reasonable combinations.

While various embodiments have been described above to illustrate the bias circuit and the control method of the present disclosure, it should be understood that they have been presented by way of example only, and not limitation. Rather, the scope of the present disclosure is defined by the following claims and includes combinations and sub-combinations of the various features described above, as well as variations and modifications thereof, which would occur to persons skilled in the art upon reading the foregoing description.

1. A charging circuit, comprising:
a charge pump circuit having a first terminal coupled to a charge pump input terminal, a second terminal coupled to an output voltage terminal, and a ground reference terminal, wherein the charge pump input terminal is configured to receive a charge pump input voltage, the output voltage terminal is configured to provide an output voltage, and the charge pump circuit comprises a plurality of charge pump power transistors, a subset of which is configured to form a linear current channel circuit; and
a linear control circuit configured to provide a first linear control signal to the linear current channel circuit, to enable the charge pump circuit to operate in a linear mode, wherein, in the linear mode, the charge pump power transistors in the linear current channel circuit are turned on under control of the first linear control signal, while remaining ones of the plurality of charge pump power transistors in the charge pump circuit are turned off; wherein
the charge pump circuit is further configured to receive a charge pump control signal, and wherein, when the charge pump circuit operates in a switching mode, the plurality of charge pump power transistors in the charge pump circuit are switched by the charge pump control signal.

2. The charging circuit of claim 1, wherein the linear control circuit comprises:
a first differential regulation circuit configured to receive the charge pump input voltage and the output voltage, and to provide the first linear control signal based on the charge pump input voltage and the output voltage.

3. The charging circuit of claim 2, wherein the first differential regulation circuit comprises:
a first subtractor circuit configured to receive the charge pump input voltage and the output voltage, and to provide a first difference voltage based on the charge pump input voltage and the output voltage; and
a first error amplifier circuit configured to receive a first difference voltage reference and the first difference voltage, and to provide the first linear control signal based on the first difference voltage reference and the first difference voltage.

4. The charging circuit of claim 2, wherein the first differential regulation circuit is configured to receive the charge pump input voltage, the output voltage, a first voltage reference and a second voltage reference, and to provide the first linear control signal based on the charge pump input voltage, the output voltage, the first voltage reference and the second voltage reference.

5. The charging circuit of claim 1, further comprising:
an overvoltage protection circuit having a first terminal coupled to an input voltage terminal, a second terminal coupled to a bus voltage terminal, and a control terminal; wherein
the linear control circuit is further configured to provide a second linear control signal to the control terminal of the overvoltage protection circuit; and wherein
when the charge pump circuit operates in the linear mode, the overvoltage protection circuit is controlled by the second linear control signal to provide a current path from the input voltage terminal to the bus voltage terminal; and
when the charge pump circuit operates in the switching mode, the overvoltage protection circuit is maintained in a pass-through state under control of a first protection switch control signal.

6. The charging circuit of claim 5, wherein the overvoltage protection circuit comprises:
an overvoltage protection power transistor having a source terminal coupled to the bus voltage terminal, a drain terminal coupled to the input voltage terminal, and a gate terminal configured to receive the second linear control signal and the first protection switch control signal.

7. The charging circuit of claim 5, wherein the overvoltage protection circuit comprises:
a first overvoltage protection power transistor, having a drain terminal coupled to the input voltage terminal, a source terminal and a gate terminal; and
a second overvoltage protection power transistor, having a source terminal coupled to the source terminal of the first overvoltage protection power transistor, a drain terminal coupled to the bus voltage terminal, and a gate terminal coupled to the gate terminal of the first overvoltage protection power transistor and configured to receive the second linear control signal and the first protection switch control signal.

8. The charging circuit of claim 1, further comprising:
a reverse current blocking circuit having a first terminal coupled to a bus voltage terminal, a second terminal coupled to the charge pump input terminal, and a control terminal; wherein
the linear control circuit further configured to provide a third linear control signal to the control terminal of the reverse current blocking circuit; and wherein
when the charge pump circuit operates in the linear mode, the reverse current blocking circuit is controlled by the third linear control signal to provide a current path from the bus voltage terminal to the charge pump input terminal; and
when the charge pump circuit operates in the switching mode, the reverse current blocking circuit is maintained in a pass-through state under control of a second protection switch control signal.

9. The charging circuit of claim 8, wherein the reverse current blocking circuit comprises:
a reverse current blocking power transistor, having a source terminal coupled to the bus voltage terminal, a drain terminal coupled to the charge pump input terminal, and a gate terminal configured to receive the third linear control signal and the second protection switch control signal.

10. The charging circuit of claim 1, further comprising:
an overvoltage protection circuit having a first terminal coupled to an input voltage terminal, a second terminal coupled to a bus voltage terminal, and a control terminal; and
a reverse current blocking circuit having a first terminal coupled to the bus voltage terminal, a second terminal coupled to the charge pump input terminal, and a control terminal; wherein
the linear control circuit is further configured to provide a second linear control signal to the control terminal of the overvoltage protection circuit and to provide a third linear control signal to the control terminal of the reverse current blocking circuit; and wherein
when the charge pump circuit operates in the linear mode, the overvoltage protection circuit is controlled by the second linear control signal to provide a current path from the input voltage terminal to the bus voltage terminal, and the reverse current blocking circuit is controlled by the third linear control signal to provide a current path from the bus voltage terminal to the charge pump input terminal; and
when the charge pump circuit operates in the switching mode, the overvoltage protection circuit is maintained in a pass-through state under control of a first protection switch control signal, and the reverse current blocking circuit is maintained in a pass-through state under control of a second protection switch control signal.

11. The charging circuit of claim 10, wherein the linear control circuit comprises:
a first differential regulation circuit configured to receive the charge pump input voltage and the output voltage, and to provide the first linear control signal based on the charge pump input voltage and the output voltage;
a second differential regulation circuit configured to receive the input voltage and the bus voltage, and to provide the second linear control signal based on the input voltage and the bus voltage; and
a third differential regulation circuit configured to receive the bus voltage and the charge pump input voltage, and to provide the third linear control signal based on the bus voltage and the charge pump input voltage.

12. The charging circuit of claim 11, wherein
the first differential regulation circuit comprises:
a first subtractor circuit configured to receive the charge pump input voltage and the output voltage, and to provide a first difference voltage based on the charge pump input voltage and the output voltage; and
a first error amplifier circuit configured to receive a first difference voltage reference and the first difference voltage, and to provide the first linear control signal based on the first difference voltage reference and the first difference voltage;
the second differential regulation circuit comprises:
a second subtractor circuit configured to receive the input voltage and the bus voltage, and to provide a second difference voltage based on the input voltage and the bus voltage; and
a second error amplifier circuit configured to receive a second difference voltage reference and the second difference voltage, and to provide the second linear control signal based on the second difference voltage reference and the second difference voltage;
the third differential regulation circuit comprises:
a third subtractor circuit configured to receive the bus voltage and the charge pump input voltage, and to provide a third difference voltage based on the bus voltage and the charge pump input voltage; and
a third error amplifier circuit configured to receive a third difference voltage reference and the third difference voltage, and to provide the third linear control signal based on the third difference voltage reference and the third difference voltage.

13. The charging circuit of claim 11, wherein,
the first differential regulation circuit is configured to receive the charge pump input voltage, the output voltage, a first voltage reference and a second voltage reference, and to provide the first linear control signal based on the charge pump input voltage, the output voltage, the first voltage reference and the second voltage reference;
the second differential regulation circuit is configured to receive the input voltage, the bus voltage, a third voltage reference and a fourth voltage reference, and to provide the second linear control signal based on the input voltage, the bus voltage, the third voltage reference and the fourth voltage reference; and
the third differential regulation circuit is configured to receive the bus voltage, the charge pump input voltage, a fifth voltage reference and a sixth voltage reference, and to provide the third linear control signal based on the bus voltage, the charge pump input voltage, the fifth voltage reference and the sixth voltage reference.

14. The charging circuit of claim 1, wherein the charge pump circuit comprises:
a first charge pump power transistor;
a second charge pump power transistor;
a third charge pump power transistor;
a fourth charge pump power transistor; and
a first flying capacitor; wherein:
the first charge pump power transistor, the second charge pump power transistor, the third charge pump power transistor, and the fourth charge pump power transistor are coupled in series between the first terminal and the ground reference terminal of the charge pump circuit, the first flying capacitor has a first terminal coupled to a connecting node of the first charge pump power transistor and the second charge pump power transistor, and a second terminal coupled to a connecting node of the third charge pump power transistor and the fourth charge pump power transistor, and a connecting node of the second charge pump power transistor and the third charge pump power transistor is coupled to the output voltage terminal; and wherein:
the linear current channel circuit comprises the first charge pump power transistor and the second charge pump power transistor.

15. The charging circuit of claim 1, wherein the charge pump circuit comprises:
a first charge pump power transistor;
a second charge pump power transistor;
a third charge pump power transistor;
a fourth charge pump power transistor;
a fifth charge pump power transistor;
a sixth charge pump power transistor;
a seventh charge pump power transistor;
an eighth charge pump power transistor;
a first flying capacitor; and
a second flying capacitor; wherein:
the first charge pump power transistor, the second charge pump power transistor, the third charge pump power transistor and the fourth charge pump power transistor are coupled in series between the first terminal and the ground reference terminal of the charge pump circuit, the first flying capacitor has a first terminal coupled to a connecting node of the first charge pump power transistor and the second charge pump power transistor, and a second terminal coupled to a connecting node of the third charge pump power transistor and the fourth charge pump power transistor, and a connecting node of the second charge pump power transistor and the third charge pump power transistor is coupled to the output voltage terminal;
the fifth charge pump power transistor, the sixth charge pump power transistor, the seventh charge pump power transistor, and the eighth charge pump power transistor are coupled in series between the first terminal and the ground reference terminal of the charge pump circuit, the second flying capacitor has a first terminal coupled to a connecting node of the fifth charge pump power transistor and the sixth charge pump power transistor, and a second terminal coupled to a connecting node of the seventh charge pump power transistor and the eighth charge pump power transistor, and a connecting node of the sixth charge pump power transistor and the seventh charge pump power transistor is coupled to the output voltage terminal; and wherein:
the linear current channel circuit comprises the first charge pump power transistor, the second charge pump power transistor, the fifth charge pump power transistor and the sixth charge pump power transistor.

16. The charging circuit of claim 1, wherein the charge pump circuit comprises:
a first charge pump power transistor;
a second charge pump power transistor;
a third charge pump power transistor;
a fourth charge pump power transistor;
a fifth charge pump power transistor;
a sixth charge pump power transistor;
a seventh charge pump power transistor;
an eighth charge pump power transistor;
a first flying capacitor;
a second flying capacitor; and
a third flying capacitor; wherein:
the first charge pump power transistor, the second charge pump power transistor, the third charge pump power transistor and the fourth charge pump power transistor are coupled in series between the first terminal and the output voltage terminal, the fifth charge pump power transistor and the sixth charge pump power transistor are coupled in series between the output voltage terminal and the ground reference terminal, the seventh charge pump power transistor and the eighth charge pump power transistor are coupled in series between the output voltage terminal and the ground reference terminal;
the first flying capacitor has a first terminal coupled to a connecting node of the first charge pump power transistor and the second charge pump power transistor, and a second terminal coupled to a connecting node of the fifth charge pump power transistor and the sixth charge pump power transistor;
the second flying capacitor has a first terminal coupled to a connecting node of the third charge pump power transistor and the fourth charge pump power transistor, and a second terminal coupled to the connecting node of the fifth charge pump power transistor and the sixth charge pump power transistor;
the third flying capacitor has a first terminal coupled to a connecting node of the second charge pump power transistor and the third charge pump power transistor, and a second terminal coupled to a connecting node of the seventh charge pump power transistor and the eighth charge pump power transistor; and wherein:
the linear current channel circuit comprises the first charge pump power transistor, the second charge pump power transistor, the third charge pump power transistor and the fourth charge pump power transistor.

17. A control method for a charging circuit, wherein the charging circuit comprises a charge pump circuit, and the charge pump circuit comprises a plurality of charge pump power transistors, the control method comprising:
determining an operating mode of the charging circuit, wherein:
when the charging circuit operates in a switching mode, turning on and off the charge pump power transistors of the charge pump circuit in a pattern; and
when the charging circuit operates in a linear mode, controlling a linear current channel circuit in the charge pump circuit to operate in the linear mode, wherein the linear current channel circuit comprises a subset of the plurality of charge pump power transistors coupled in series between a charge pump input terminal and an output voltage terminal of the charge pump circuit.

18. The control method of claim 17, wherein controlling the linear current channel circuit in the charge pump circuit to operate in the linear mode comprises:
providing a first linear control signal based on a voltage difference between the charge pump input terminal and the output voltage terminal; and
applying the first linear control signal to the charge pump power transistors in the linear current channel circuit to provide a current path.

19. The control method of claim 17, wherein an overvoltage protection circuit is coupled between an input voltage terminal and a bus voltage terminal of the charging circuit, and wherein the overvoltage protection circuit comprises one or more series-connected overvoltage protection power transistors, and the control method further comprises:
in the linear mode, controlling the one or more series-connected overvoltage protection power transistors based on a second linear control signal, wherein the second linear control signal is generated based on a voltage difference between an input terminal and an output terminal of the overvoltage protection circuit;
in the switching mode, controlling the one or more series-connected overvoltage protection power transistors based on a first protection switch control signal.

20. The control method of claim 17, wherein a reverse current blocking circuit is coupled between a bus voltage terminal and the charge pump input terminal of the charging circuit, and wherein the reverse current blocking circuit comprises at least one reverse current blocking power transistor, and the control method further comprises:
in the linear mode, controlling the at least one reverse current blocking power transistor based on a third linear control signal, wherein the third linear control signal is generated based on a voltage difference between an input terminal and an output terminal of the reverse current blocking circuit;
in the switching mode, controlling the at least one reverse current blocking power transistor based on a second protection switch control signal.
